(19) United States
(12) Patent Application Publication
(10) Pub. No.: US 2017/0269878 A1
(43) Pub. Date: Sep. 21, 2017

(54) SERVER, IMAGE FORMING APPARATUS, AND IMAGE FORMING SYSTEM

(71) Applicant: Masashi Taniguchi, Kanagawa (JP)

(72) Inventor: Masashi Taniguchi, Kanagawa (JP)

(73) Assignee: Ricoh Company, Ltd., Tokyo (JP)

(21) Appl. No.: 15/453,724

(22) Filed: Mar. 8, 2017

(30) Foreign Application Priority Data
Mar. 16, 2016 (JP) 2016053027

(51) Int. Cl. G06F 3/12; G05D 1/02; H04N 1/00

(52) U.S. Cl. CPC G06F 3/1204; G06F 3/1288; H04N 1/00244; H04N 1/00408; G06F 3/126; G05D 1/0212; H04N 2201/0082

(57) ABSTRACT

A server includes circuitry to receive, from an information processing apparatus, a print condition, a print file to be printed, and position information of the information processing apparatus, generate a travel route of a self-propelled image forming apparatus based on the position information of the information processing apparatus, position information of the self-propelled image forming apparatus, and map data, instruct the self-propelled image forming apparatus to move to a destination, determine, in response to a print continuation request received from the self-propelled image forming apparatus, whether a continued-printing operation is allowed for the self-propelled image forming apparatus, instruct the self-propelled image forming apparatus to stay at a current location when the circuitry determines that the continued-printing operation is allowed, identify continued-printing print data transmitted from the information processing apparatus, and transmit the continued-printing print data to the self-propelled image forming apparatus being stayed at the current location.

### CROSS-REFERENCE TO RELATED APPLICATIONS

This application claims priority pursuant to 35 U.S.C. §119(a) to Japanese Patent Application No. 2016-053027, filed on Mar. 16, 2016 in the Japan Patent Office, the disclosure of which are incorporated by reference herein in its entirety.

### BACKGROUND

Technical Field

This disclosure related to a server, an image forming apparatus, and an image forming system.

Background Art

Typically, one or more image forming apparatuses are shared by a plurality of users in offices. For example, in JP-2015083514-A, at least one self-propelled image forming apparatus that can travel autonomously may be shared by the plurality of users. When one user requests a printing operation, the self-propelled image forming apparatus travels to that user who has requested the printing operation and performs the printing operation.

In JP-2015083514-A, the self-propelled image forming apparatus can be used as follows. (1) When a print request is output from a host apparatus of a user A, the self-propelled image forming apparatus prints an image based on a received print job to output a print product, and then the self-propelled image forming apparatus delivers the print product to the host apparatus (user A) that has requested the printing. (2) The self-propelled image forming apparatus may sequentially receive a print job from a user B and a print job from a user C when the self-propelled image forming apparatus is printing a print job for the user A. In this case, if a location of the user C is close to a location of the user A, the self-propelled image forming apparatus does not deliver the print product to the user A even if the print job of the user A is completed, but the self-propelled image forming apparatus performs printing according to the print job of the user C. (3) After completing the print job of the user C, the self-propelled image forming apparatus delivers the print product of the print job to the user A and the print product of the print job to the user C.

As described above, in this technology, the printing sequence of print jobs can be changed in view of delivery locations of the print products input to the self-propelled image forming apparatus to increase the delivery efficiency of the self-propelled image forming apparatus.

### SUMMARY

As one aspect of the present invention, a server is devised. The server includes circuitry to receive, from an information processing apparatus via a network, a print condition, a print file to be printed, and position information of the information processing apparatus, generate a travel route of a self-propelled image forming apparatus to be used in printing the print file, based on the position information of the information processing apparatus, position information of the self-propelled image forming apparatus, and map data, instruct the self-propelled image forming apparatus to move to a destination according to the travel route, determine, in response to a print continuation request received from the self-propelled image forming apparatus, whether a continued-printing operation is allowed for the self-propelled image forming apparatus, instruct the self-propelled image forming apparatus to stay at a current location when the circuitry determines that the continued-printing operation is allowed for the self-propelled image forming apparatus at the current location, the current location being the destination, identify continued-printing print data to be used for the continued-printing operation transmitted from the information processing apparatus, and transmit the continued-printing print data to the self-propelled image forming apparatus being stayed at the current location.

As another aspect of the present invention, an image forming apparatus communicable with a server via a network is devised. The image forming apparatus includes an autonomous traveling apparatus to travel autonomously based on an instruction received from the server, and an image forming unit including first circuitry to receive data from the server via the network, interpret the received data to generate a print image to be used for a printing operation, report a request for a continued-printing operation to the server, receive a stay instruction from the server when the continued-printing operation is allowed for the image forming apparatus at a current location of the image forming apparatus, receive print data used for the continued-printing operation from the server, print the print data used for the continued-printing operation received from the server at the current location of the image forming apparatus being in a staying status, determine whether the continued-printing operation is ended, report that the continued-printing operation is ended to the server when an end of the continued-printing operation is determined, and cancel the staying status of the image forming apparatus when the end of the continued-printing operation is determined.

As another aspect of the present invention, an image forming system is devised. The image forming system includes a server, and an image forming apparatus coupled to the server via a network. The server includes circuitry to receive, from an information processing apparatus via a network, a print condition, a print file to be printed, and position information of the information processing apparatus, generate a travel route of a self-propelled image forming apparatus to be used in printing the print file, based on the position information of the information processing apparatus, position information of the self-propelled image forming apparatus, and map data, instruct the self-propelled image forming apparatus to move to a destination according to the travel route, determine, in response to a print continuation request received from the self-propelled image forming apparatus, whether a continued-printing operation is allowed for the self-propelled image forming apparatus, instruct the self-propelled image forming apparatus to stay at a current location when the circuitry determines that the continued-printing operation is allowed for the self-propelled image forming apparatus at the current location, the current location being the destination, identify continued-printing print data to be used for the continued-printing operation transmitted from the information processing apparatus, and transmit the continued-printing print data to the self-propelled image forming apparatus being stayed at the current location. The image forming apparatus includes an autonomous traveling apparatus to travel autonomously based on an instruction from the server, and an image forming unit including circuitry to receive data from the server via the network, interpret the received data to generate a print image to be used for a printing operation, report a request for a continued-printing operation to the server, receive a stay instruction from the server when the continued-printing operation is allowed for the image forming apparatus at a current location of the image forming apparatus, receive print data used for the continued-printing operation from the server, print the print data used for the continued-printing operation received from the server at the current location of the image forming apparatus being in a staying status, determine whether the continued-printing operation is ended, report that the continued-printing operation is ended to the server when an end of the continued-printing operation is determined, and cancel the staying status of the image forming apparatus when the end of the continued-printing operation is determined.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a schematic block diagram of an autonomous traveling and image forming system of an embodiment of the present invention;

FIG. 2A is a schematic perspective view of a self-propelled image forming apparatus employed for the autonomous traveling and image forming system of FIG. 1;

FIG. 2B is a schematic cross-sectional view of the self-propelled image forming apparatus of FIG. 2A including an image forming apparatus and an autonomous traveling apparatus;

FIG. 3 is a schematic communication diagram of the self-propelled image forming apparatus and a server employed for the autonomous traveling and image forming system of FIG. 1;

FIG. 4 is a schematic block diagram of a hardware configuration of the image forming apparatus employed for the autonomous traveling and image forming system of FIG. 1;

FIG. 5 is a schematic block diagram of a hardware configuration of the autonomous traveling apparatus employed for the autonomous traveling and image forming system of FIG. 1;

FIG. 6 is a schematic block diagram of a hardware configuration of the server employed for the autonomous traveling and image forming system of FIG. 1;

FIG. 7 is a schematic functional block diagram of the image forming apparatus of FIG. 4;

FIG. 8 is a schematic functional block diagram of the autonomous traveling apparatus of FIG. 5;

FIG. 9 is a schematic functional block diagram of the server of FIG. 6

FIG. 10 is an example of sequential chart of processes performed in the autonomous traveling and image forming system of FIG. 1;

FIG. 11 is a flowchart illustrating steps of a process performed for the self-propelled image forming apparatus of a first embodiment when a continued printing operation is completed;

FIG. 12 is a flowchart illustrating steps of a process of the self-propelled image forming apparatus of a second embodiment when a continued printing operation is completed; and

FIG. 13 is a flowchart illustrating steps of a process of the self-propelled image forming apparatus of a third embodiment when a continued printing operation is completed.

The accompanying drawings are intended to depict exemplary embodiments of the present disclosure and should not be interpreted to limit the scope thereof. The accompanying drawings are not to be considered as drawn to scale unless explicitly noted, and identical or similar reference numerals designate identical or similar components throughout the several views.

### DETAILED DESCRIPTION

A description is now given of exemplary embodiments of the present disclosure. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present disclosure.

In addition, it should be noted that the terminology used herein is for the purpose of describing particular embodiments only and is not intended to be limiting of the present disclosure. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views illustrated in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, a description is given one or more apparatuses or systems of one or more embodiments of the present disclosure.

The inventor of the present invention have realized that there is a case when the delivery efficiency is lowered in the above-described conventional technology. In the above-described conventional technology, when the user A inputs a print request (first print request) to a server, the server instructs the self-propelled image forming apparatus to move to the user A, and then to process the first print request at the user A. In this case, the user A may input a new print request (second print request) to the server when the user A receives the print product of the first print request. However, if another user such as the user B inputs another print request (third print request) to the server before the user A inputs the second print request to the server, the self-propelled image forming apparatus moves to the user B to perform the printing at the user B, and then the self-propelled image forming apparatus moves to the user A again to perform the printing for the second print request at the user A. Therefore, even if the self-propelled image forming apparatus is present at the user A when the user A inputs the second print request to the server, the user A cannot use the self-propelled image forming apparatus to perform the printing of the second print request at the user A until the self-propelled image forming apparatus completes the printing at the user B.

In view of the above, as disclosed in this disclosure, a self-propelled image forming apparatus is disposed in an autonomous traveling and image forming system shared by a plurality of users. If one user requests an additional printing (i.e., continued-printing operation) when or after the self-propelled image forming apparatus has performed one printing operation at the one user, a server determines whether the self-propelled image forming apparatus that has received the request for continued-printing operation from the one user can perform the continued-printing operation at the one user right after the one printing operation. If the server determines that the self-propelled image forming apparatus can perform the continued-printing operation at the one user right after the one printing operation, the self-propelled image forming apparatus is kept stayed at a current location of the one user, and the server instructs the self-propelled image forming apparatus to perform the printing operation of a new print job (i.e., continued-printing operation), input from the one user, at the current location of the one user right after the one printing operation.

A description is given of an autonomous traveling and image forming system of an embodiment of the present invention with reference to the drawings.

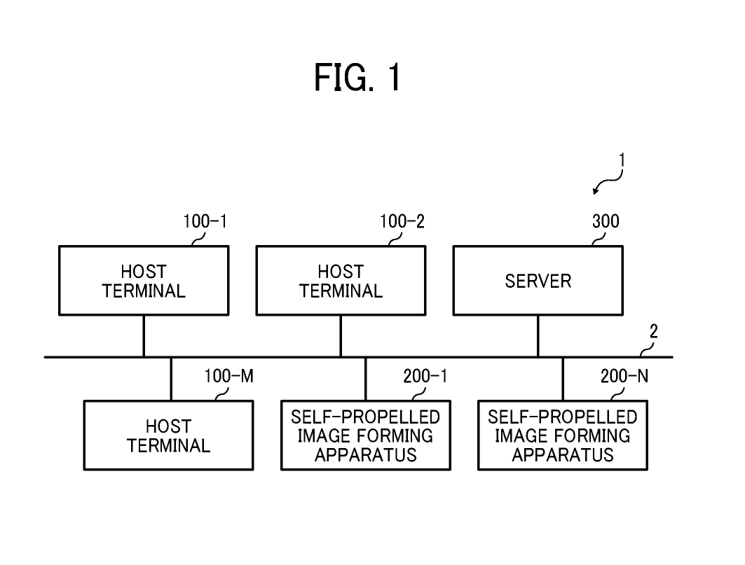

FIG. 1 is a schematic block diagram of an autonomous traveling and image forming system 1 of an embodiment of the present invention. In this description, the autonomous traveling and image forming system 1 is devised to autonomously move an image forming apparatus among a plurality of users to perform an image forming operation at each one of the users. As described in FIG. 1, the autonomous traveling and image forming system 1 includes, for example, a server 300, a plurality of host terminals 100 and one or more self-propelled image forming apparatuses 200, which can be coupled or connected with each other via a network 2. The plurality of host terminals 100 includes, for example, host terminals 100-1, 100-2, . . . , 100-M (M is an integer of one or more), and the one or more self-propelled image forming apparatuses 200 includes, for example, image forming apparatuses 200-1, 200-2, . . . , 200-N (N is an integer of one or more). The server 300 is coupled or connected to the network 2. Each one of the host terminals 100-1, 100-2, and 100-M is coupled or connected to the network 2. Each one of the self-propelled image forming apparatuses 200-1, 200-2, and 200-N is coupled or connected to the network 2. Hereinafter, any one or more of the plurality host terminals 100-1, 100-2, and 100-M is simply referred to as the host terminal 100, and any one or more of the plurality of the self-propelled image forming apparatuses 200-1, 200-2, and 200-N is simply referred to as the self-propelled image forming apparatus 200, as needed.

As to the autonomous traveling and image forming system 1, the server 300 receives data transmitted from the host terminal 100 (e.g., PC, mobile terminal) via the network 2 using wireless communication. When the server 300 receives the data with a print request from the host terminal 100, the server 300 determines a user location of the host terminal 100 that has transmitted the print request to the server 300, and instructs the self-propelled image forming apparatus 200 to move to the user location of the host terminal 100 that has transmitted the print request to the server 300. Further, the server 300 transmits the data to the self-propelled image forming apparatus 200 while the self-propelled image forming apparatus 200 is moving or after the self-propelled image forming apparatus 200 arrives at the user location of the host terminal 100 that has transmitted the print request to the server 300. After receiving the data, the self-propelled image forming apparatus 200 interprets the received data, generates image data based on the received data, and prints the image data.

Further, the network 2 employs, for example, a local area network (LAN) or the Internet, which can use a public line such as a telephone line. Further, in an example case of FIG. 1, the plurality of the host terminals 100 and the plurality of the self-propelled image forming apparatuses 200 are coupled or connected to the network 2 to configure the autonomous traveling and image forming system 1, but the number of the host terminals 100 and the number of the self-propelled image forming apparatuses 200 can be one. Further, in an example case of FIG. 1, one common network such as the network 2 is used for the autonomous traveling and image forming system 1, but the autonomous traveling and image forming system 1 can be configured using different networks.

Further, the network 2 can employ, for example, interfaces such as Ethernet registered trademark), USB (Universal Serial Bus), Bluetooth (registered trademark), Wi-Fi (Wireless Fidelity: registered trademark), FeliCa (registered trademark), PCIe (Peripheral Component Interconnect Express), VGA (Video Graphic Array), DVI (Digital Visual Interface), and IEEE (The Institute of Electrical and Electronics Engineers) standard.

Each one of the host terminals 100 is an information processing terminal that can be operated by a user. The host terminal 100 is, for example, a personal computer (PC), or a mobile information terminal such as personal digital assistant (PDA), smart phone, and tablet terminal.

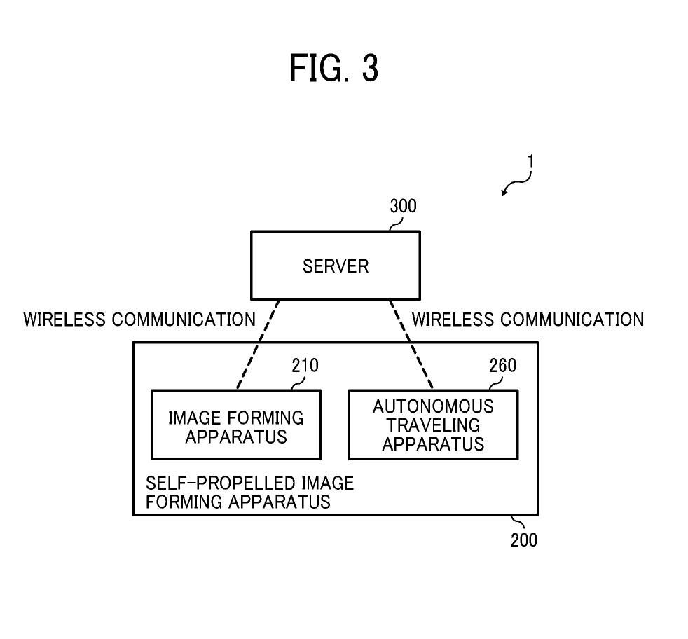

Further, based on a user operation of each one of the host terminals 100, each one of the host terminals 100 transmits electronic data (hereinafter, print file) to the server 300, which is a print target of the self-propelled image forming apparatus 210 such as a printer (see FIG. 3) to store print files in the server 300, and each one of the host terminals 100 transmits a print instruction to the server 300 for a print file selected from print files stored in the server 300.

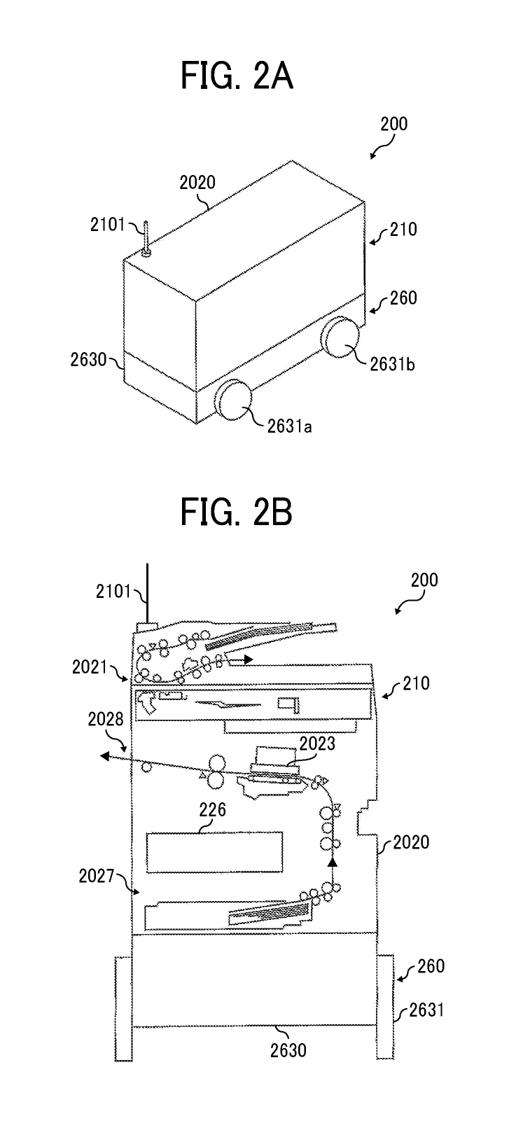

As indicted in FIG. 2, the self-propelled image forming apparatus 200 includes an image forming apparatus 210 and an autonomous traveling apparatus 260. The server 300 disposed on the network 2 manages the image forming apparatus 210 so that each one of the host terminals 100 can use the image forming apparatus 210. Further, the server 300 stores one or more print files transmitted from each one of the host terminals 100 based on a print instruction transmitted from each one of the host terminals 100, and the server 300 instructs the image forming apparatus 210 to print a print file selected from the stored print files.

FIG. 2 is a schematic configuration of the self-propelled image forming apparatus 200 including the image forming apparatus 210 and the autonomous traveling apparatus 260. FIG. 2A is a schematic perspective view of the self-propelled image forming apparatus 200, and FIG. 2B is a schematic cross-sectional view of the self-propelled image forming apparatus 200 including the image forming apparatus 210 and the autonomous traveling apparatus 260.

The self-propelled image forming apparatus 200 includes the image forming apparatus 210 as an upper apparatus and the autonomous traveling apparatus 260 as a lower apparatus. The self-propelled image forming apparatus 200 can be used as the self-propelled image forming apparatus (i.e., robot image forming apparatus). Specifically, the image forming apparatus 210 includes a first communication unit 2101 to receive a user command from the information processing apparatus such as PC and PDA. When the image forming apparatus 210 receive the user command, the image forming apparatus 210 performs the image forming operation based on the user command, and moves to a location designated by the user command to deliver a print product to the user.

The image forming apparatus 210 is, for example, an ink jet image forming apparatus having multiple capabilities such as copier, printer, and facsimile. The image forming apparatus 210 includes, for example, a main unit 2020, an image scanner 2021, a print head 2023, a printer drive battery 226, a sheet feed unit 2027, and a sheet ejector 2028.

The main unit 2020 includes a casing of the image forming apparatus 210. The image scanner 2021 is disposed above the main unit 2020 to scan a document image. The print head 2023 is disposed along a conveyance route of a sheet, in which the print head 2023 dispenses ink on the sheet to form an image on the sheet.

The printer drive battery 226 is a storage battery used as a power unit. The sheet feed unit 2027 is disposed at the lower part of the main unit 2020 to store a plurality of sheets such as paper and to feed the sheets one by one. The sheet ejector 2028 is disposed at one side of the main unit 2020 to stack the sheets printed with images. Since the ink jet image forming apparatus is known technologies, the detail of ink jet image forming apparatus is not described.

The printer drive battery 226 used as the storage battery is, for example, a secondary battery such as lithium-ion rechargeable battery. The printer drive battery 226 can be used as a rechargeable battery that can be charged multiple times by using a power supply source. The printer drive battery 226 supplies power to each unit in the main unit 2020 and other unit.

The storage battery is not limited to the secondary battery such as lithium-ion rechargeable battery, but the storage battery can employ ultracapacitor such as electric double-layer capacitor. Compared to the secondary battery such as lithium-ion rechargeable battery, the ultracapacitor has smaller charge capacity, and the ultracapacitor is required to be charged with a shorter time interval. The ultracapacitor has the smaller charge capacity, but the ultracapacitor is less affected by the charge—discharge and the ultracapacitor is good at a rapid charge—discharge behavior. Therefore, the ultracapacitor can be charged with a shorter time, and the ultracapacitor can be maintenance free.

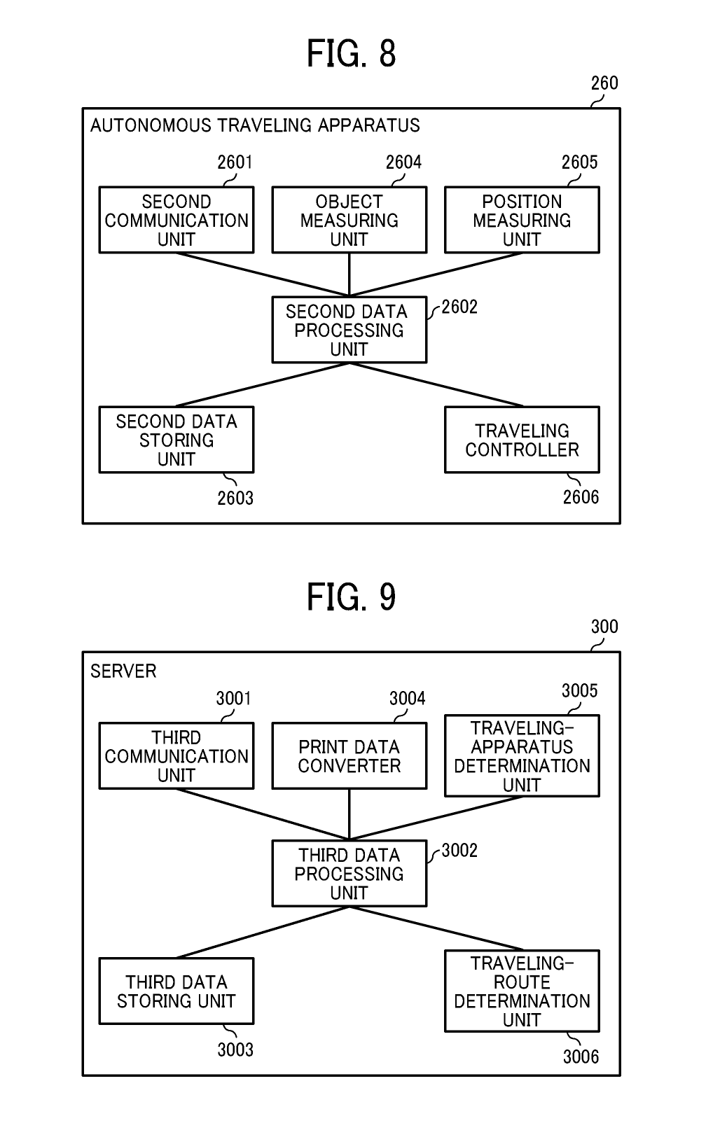

The autonomous traveling apparatus 260 includes, for example, a casing 2630, a traveling unit 2631 as a traveling mechanism, and a traveling controller 2606 that controls the traveling mechanism (FIG. 8). Since the image forming apparatus 210 is disposed on the casing 2630 of the autonomous traveling apparatus 260, the autonomous traveling apparatus 260 can travel to a user location designated by a user by using the second communication unit 2601 (FIG. 8).

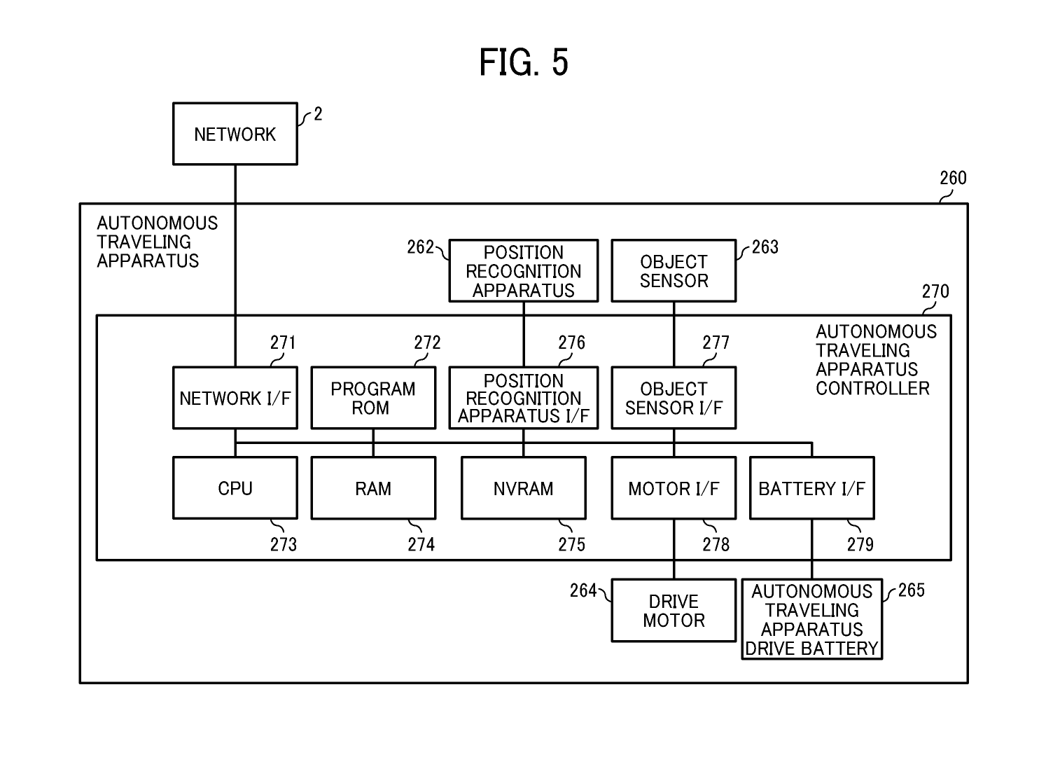

As indicted in FIG. 2, the autonomous traveling apparatus 260 includes, for example, a drive motor 264 (FIG. 5) that drives a front wheel unit 2031a and a rear wheel unit 2031b of the traveling unit 2631, and a steering unit for steering the front wheel unit 2031a and the rear wheel unit 2031b, or the front wheel unit 2031a alone. The traveling unit 2631 used as the traveling mechanism is not limited to a four-wheel drive but the traveling mechanism can be a two-wheel drive. Further, the traveling mechanism can be a three-wheel drive or a multiple-wheel drive, or a caterpillar.

FIG. 3 is a schematic communication diagram of the self-propelled image forming apparatus 200 and the server 300 in the autonomous traveling and image forming system 1. As to the autonomous traveling and image forming system 1, the self-propelled image forming apparatus 200 includes the image forming apparatus 210 and the autonomous traveling apparatus 260. Each of the image forming apparatus 210 and the autonomous traveling apparatus 260 can perform wireless communication with the server 300 via the network 2 as described in FIG. 3. When the image forming apparatus 210 receives print data and a command related to a control of the image forming apparatus 210 from the server 300, the image forming apparatus 210 reports an apparatus status to the server 300. When the autonomous traveling apparatus 260 receives information related to one or more target destinations and a travel route from the server 300, the autonomous traveling apparatus 260 reports the apparatus information such as position information of the autonomous traveling apparatus 260 to the server 300.

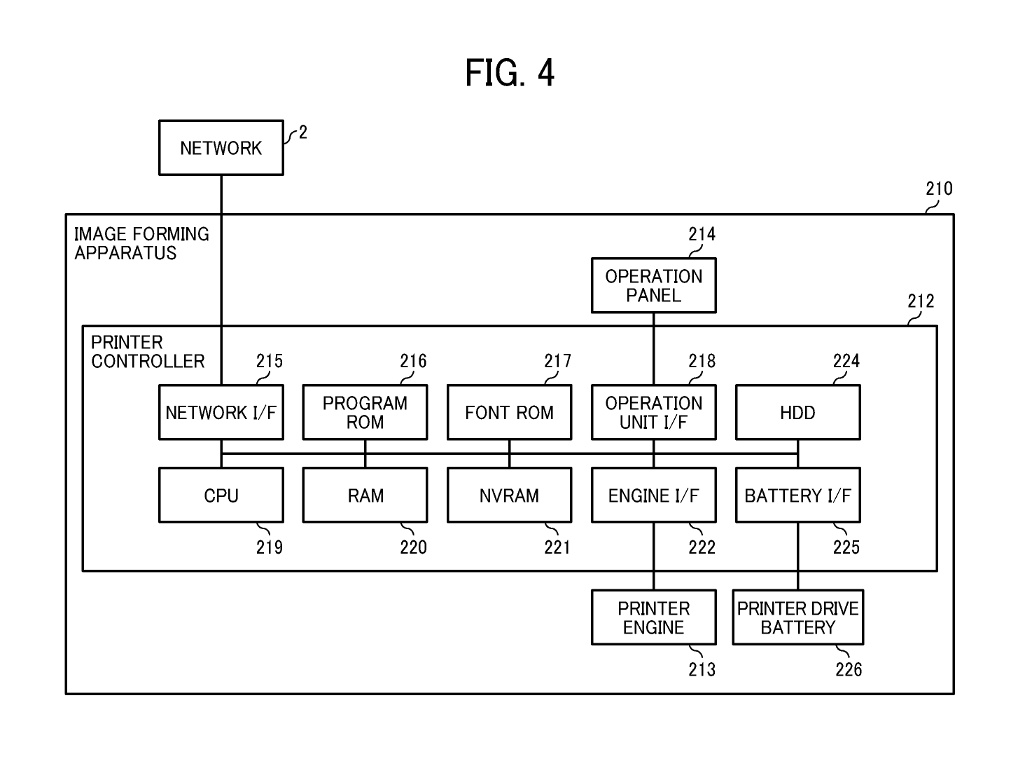

FIG. 4 is a schematic block diagram of a hardware configuration of the image forming apparatus 210 employed for the autonomous traveling and image forming system 1. As described in FIG. 4, the image forming apparatus 210 such as a printer includes, for example, a printer controller 212, a printer engine 213, an operation panel 214 (operation unit), and the printer drive battery 226. The printer controller 212 controls the image forming apparatus 210. The printer engine 213 is used to print an image on a sheet such as paper. The operation panel 214 is used by a user to input information to the image forming apparatus 210, or displays a status of the image forming apparatus 210. The image forming apparatus 210 is coupled to the network 2.

The printer controller 212 communicates with the server 300 via the network 2. The printer engine 213 controls the print head 2023 based on signals from the printer controller 212, and further controls the sheet feed unit 2027 to feed a recording sheet to form an image on the recording sheet. The operation panel 214 includes a display used as a user interface. For example, a user can input information via the operation panel 214, and further, the operation panel 214 can display a status of the image forming apparatus 210. The printer drive battery 226 is used as a battery to drive the image forming apparatus 210.

The printer controller 212 is used as a controller to control the printer engine 213. Specifically, the printer controller 212 converts print data received from the host terminal 100 to another data based on a control mode currently set to the printer controller 212, and a control code received from the host terminal 100, and outputs the converted data to the printer engine 213. As described in FIG. 4, the printer controller 212 includes, for example, a plurality of circuits such as a network interface (I/F) 215, a program read only memory (PROM) 216, a font ROM 217, an operation unit interface (I/F) 218, a central processing unit (CPU) 219, a random access memory (RAM) 220, a non-volatile random access memory (NVRAM) 221, an engine interface (I/F) 222, a hard disk drive (HDD) 224, and a battery interface (I/F) 225.

The network I/F215 is used as an interface for communicating with the server 300. The PROM 216 stores a program for controlling data management in the printer controller 212 and a program for controlling various modules or circuits. The font ROM 216 stores various types of font used for the printing operation. The operation unit I/F218 is used as an interface of the operation panel 214.

The CPU 219 processes data transmitted from the host terminal 100 such as print data and controls data based on instructions described in the program stored in the ROM 216. The RAM 220 is used as a working memory when the CPU 219 processes data. For example, the RAM 220 can be used as a buffer to temporarily store data transmitted from the host terminal 100, and the RAM 220 can be used as a memory for processing the data stored in the buffer.

The NVRAM 221 is a non-volatile memory to store data even when the power supply is turned off. The engine I/F 222 is an interface used for controlling the printer engine 213 from the printer controller 212. The HDD 224 is a large capacity memory to store large data as readable and writeable data. The battery I/F225 is an interface for the printer drive battery 226.

FIG. 5 is a schematic block diagram of a hardware configuration of the autonomous traveling apparatus 260 employed for the autonomous traveling and image forming system 1. As described in FIG. 5, the autonomous traveling apparatus 260 includes, for example, an autonomous traveling apparatus controller 270 that controls the autonomous traveling apparatus 260, a position recognition apparatus 262, an object sensor 263, a drive motor 264, and an autonomous traveling apparatus drive battery 265. The autonomous traveling apparatus 260 is coupled to the network 2.

The autonomous traveling apparatus 260 communicates with the server 300 via the network 2. The position recognition apparatus 262 can employ known technologies such as an apparatus using the global positioning system (GPS), an apparatus using detection signals such as infrared light, ultrasonic wave, radio frequency signal, ultra wideband, and image information but not limited thereto. The position recognition apparatus 262 is used to recognize or measure a current position of the autonomous traveling apparatus 260. The object sensor 263 is used to detect an object existing on a travel route of the autonomous traveling apparatus 260. The object sensor 263 employs, for example, a laser range finder (LRF) as a range finder. The LRF emits light such as a laser beam, and receives the light reflected from the object. The object sensor 263 can measure a distance to the object based on a time difference between a time point when the light is emitted and a time point when the light is received and a phase difference of the emitted light phase and the received light phase. The object sensor 263 measures the distance from the autonomous traveling apparatus 260 to the object by scanning the light in a horizontal direction.

The drive motor 264 is used as a motor to drive the autonomous traveling apparatus 260. The autonomous traveling apparatus drive battery 265 is used as a battery to supply a power to the drive motor 264 and other units used for driving the autonomous traveling apparatus 260.

The autonomous traveling apparatus controller 270 is used as a controller to control the autonomous traveling of the autonomous traveling apparatus 260 to one or more target destinations based on a control mode currently set to the autonomous traveling apparatus controller 270, and a control code received from the host terminal 100a. The autonomous traveling apparatus controller 270 includes a plurality of circuits such as a network I/F 271, a program ROM 272, a CPU 273, a RAM 274, a NVRAM 275, a position recognition apparatus I/F 276, an object sensor I/F 277, a motor I/F 278 and a battery I/F 279.

The network I/F 271 is used as an interface for communicating with the server 300. The program ROM 272 stores a program for controlling data management in the autonomous traveling apparatus controller 270 and a program for controlling various modules or circuits. The CPU 273 processed data based on instructions described in the program stored in the program ROM 272. The RAM 274 is used as a working memory when the CPU 273 processes data. The NVRAM 275 is a non-volatile memory to store data even when the power supply is turned off.

The position recognition apparatus I/F 276 is used as an interface to control the position recognition apparatus 262 by the autonomous traveling apparatus controller 270. The object sensor I/F277 is used as an interface to control the object sensor 263 by the autonomous traveling apparatus controller 270. The motor I/F278 is used as an interface to control the drive motor 264 of the autonomous traveling apparatus 260 by the autonomous traveling apparatus controller 270. The battery I/F279 is used as an interface to control the autonomous traveling apparatus drive battery 265 by the autonomous traveling apparatus controller 270.

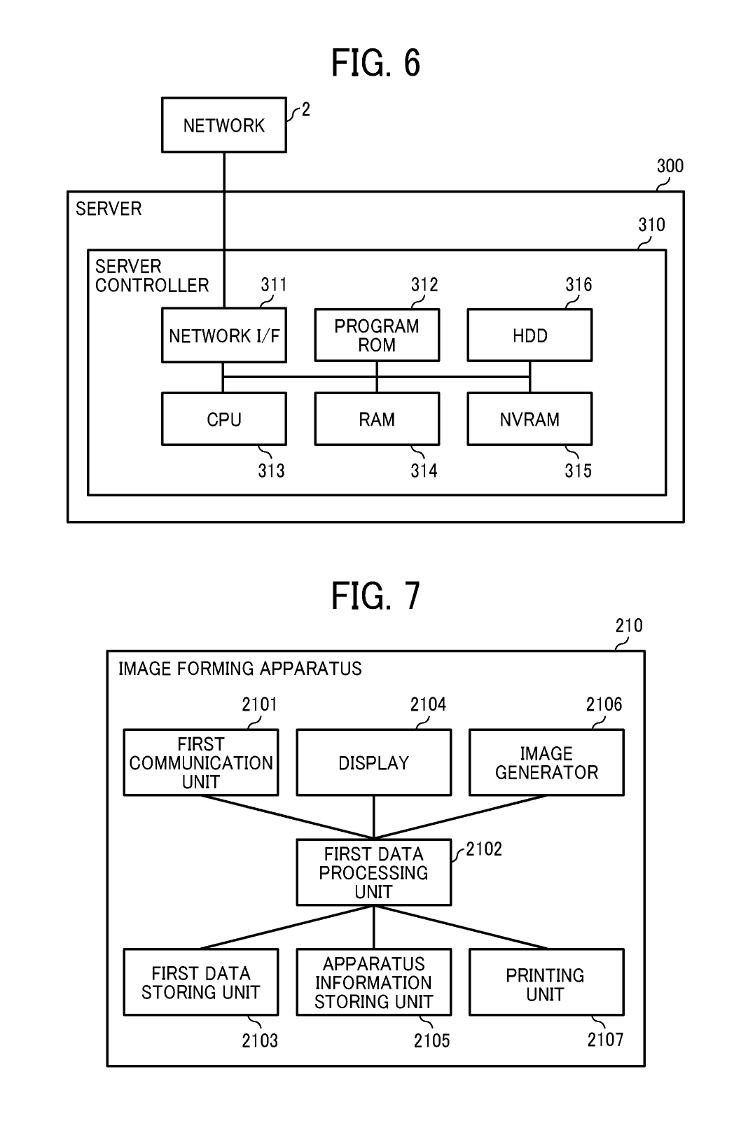

FIG. 6 is a schematic block diagram of a hardware configuration of the server 300 employed for the autonomous traveling and image forming system 1. As described in FIG. 6, the server 300 includes, for example, a server controller 310 that controls the server 300. The server 300 is coupled to the network 2. The server controller 310 determines the self-propelled image forming apparatus 200 used for the system, generates a travel route of the self-propelled image forming apparatus 200 used for the system, further, manages and converts data based on a control code received from the host terminal 100. As described in FIG. 6, the server controller 310 includes, for example, a plurality of circuits such as a network I/F311, a program ROM 312, a CPU 313, a RAM 314, a NVRAM 315, and a HDD 316. The network 2 is used to communicate information among the server 300, the host terminal 100, and the self-propelled image forming apparatus 200.

The network I/F311 is used as an interface for communicating information with the host terminal 100 and the self-propelled image forming apparatus 200. The program ROM 312 stores a program for controlling data management in the server controller 310 and a program for controlling various modules or circuits.

The CPU 313 processes data based on instructions described in the program stored in the program ROM 312. The RAM 314 is used as a working memory when the CPU 313 processes data. The NVRAM 315 is a non-volatile memory to store data even when the power supply is turned off. The HDD316 is a large capacity memory to store large data as readable and writeable data. As to the autonomous traveling and image forming system 1, print data received from the host terminal 100, and map data storing a home position of the host terminal 100, a home position of the self-propelled image forming apparatus 200, and positions of other devices are retained.

FIG. 7 is a schematic functional block diagram of the image forming apparatus 210 employed for the autonomous traveling and image forming system 1. As described in FIG. 7, the image forming apparatus 210 includes, for example, a first data processing unit 2102, a first communication unit 2101, a first data storing unit 2103, a display 2104, an apparatus information storing unit 2105, an image generator 2106, and a printing unit 2107, which are coupled to or connected to the first data processing unit 2102 for communicating data with each other. The first communication unit 2101 can communicate with an external apparatus such as the server 300 wirelessly, in which the first communication unit 2101 communicates data with the server 300. The image forming apparatus 210 can be used as an image forming unit in this description.

The first communication unit 2101 can employ an interface card (NIC) complied to the wireless LAN standard 802.11g. By employing the wireless LAN standard, the first communication unit 2101 can wirelessly communicate with a plurality of information processing apparatuses used by a plurality of users and a consumable supply apparatus bi-directionally. Further, other wireless LAN standards such as IEEE802.11a/IEEE802.11b/IEEE802.11n can be employed for the first communication unit 2101, in which a network board complied to IEEE802.11a/IEEE802.11b standard is used for data communication, and a communication control program to control the network board is used to configure a wireless LAN. Further, other wireless standard such as Bluetooth (registered trademark) standard can be employed for the first communication unit 2101. Further, the interface card can be disposed as an extended card or, the interface card can be disposed as a standard card to configure the wireless communication.

The first data processing unit 2102 determines whether the print head 2023 of the image forming apparatus 210 requires a maintenance. The first data storing unit 2103 retains a threshold data (e.g., threshold time) used for determining whether the print head 2023 requires the maintenance.

The display 2104 is used as a user interface to receive an instruction from a user, and to report a message to the use. The apparatus information storing unit 2105 retains apparatus information such as internet protocol (IP) address, and further retains an elapsed time from the most recent printing operation. The image generator 2106 generates an image based on print data. The printing unit 2107 outputs the image generated by the image generator 2106 onto a sheet such as paper.

FIG. 8 is a schematic functional block diagram of the autonomous traveling apparatus 260 employed for the autonomous traveling and image forming system 1. As described in FIG. 8, the autonomous traveling apparatus 260 includes, for example, a second data processing unit 2602, a second communication unit 2601, a second data storing unit 2603, an object measuring unit 2604, a position measuring unit 2605, and a traveling controller 2606, which are coupled to or connected to the second data processing unit 2602.

The second communication unit 2601 communicates with the server 300. For example, the second communication unit 2601 communicates data with the server 300. The second data processing unit 2602 processes data related to each of the units 2601, 2603, 2604, 2605, and 2606. The second data storing unit 2603 manages a travel route information of the autonomous traveling apparatus 260. The object measuring unit 2604 recognizes or measures whether an object exists on a travel route of the autonomous traveling apparatus 260 by using the object sensor 263. The position measuring unit 2605 measures position information of the autonomous traveling apparatus 260. The traveling controller 2606 controls the traveling or movement of the autonomous traveling apparatus 260 based on information received from the server 300, the measured position information, and object existence/non-existence information.

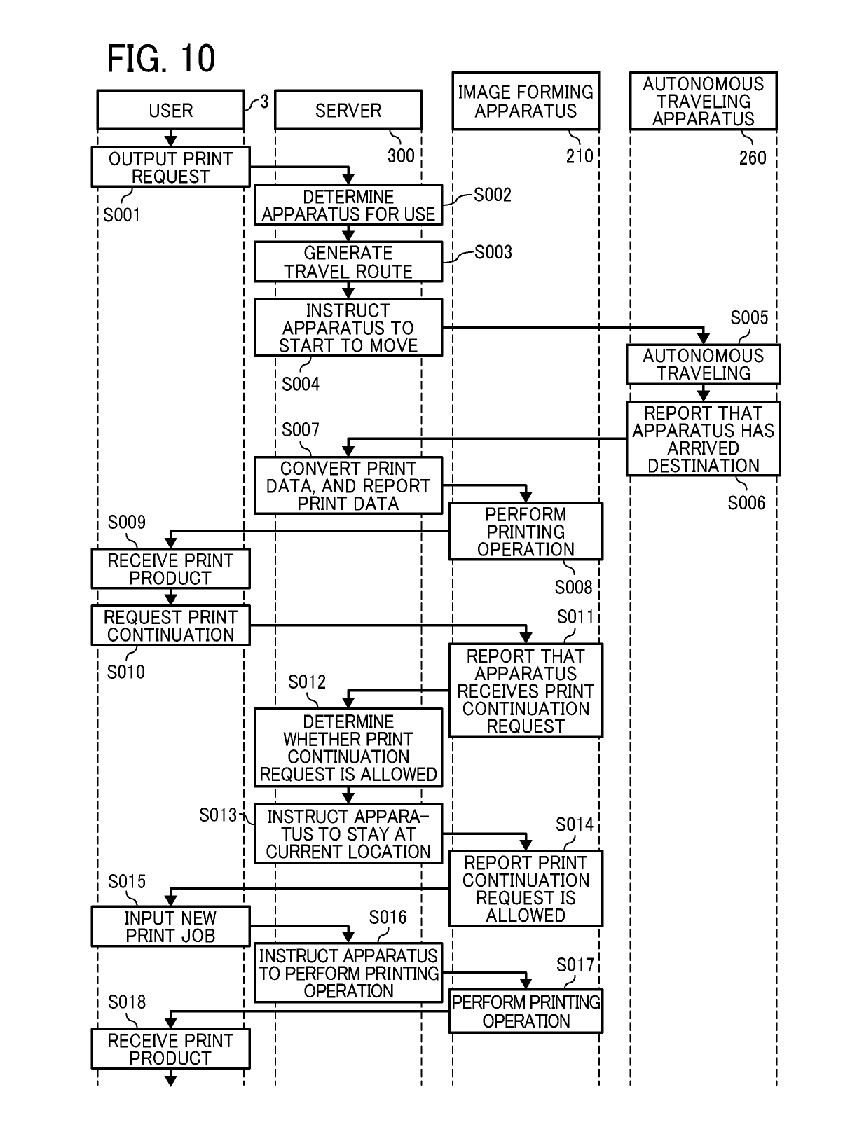

FIG. 9 is a schematic functional block diagram of the server 300 employed for the autonomous traveling and image forming system 1. As described in FIG. 9, the server 300 includes, for example, a third data processing unit 3002, a third communication unit 3001, a third data storing unit 3003, a print data converter 3004, a traveling-apparatus determination unit 3005, and a traveling-route determination unit 3006, which are coupled to or connected to the third data processing unit 3002. The third communication unit 3001 communicates with the host terminal 100, the image forming apparatus 210, and the autonomous traveling apparatus 260, in which the third communication unit 3001 communicates data with the host terminal 100, the image forming apparatus 210, and the autonomous traveling apparatus 260. The third data processing unit 3002 processes data related to each of the units 3001, 3003, 3004, 3005, and 3006. The third data storing unit 3003 retains map data and/or and print data received from the host terminal 100.

The print data converter 3004 converts print file data received from the host terminal 100 to print data that the image forming apparatus 210 can interpret. The traveling-apparatus determination unit 3005 determines which autonomous traveling apparatus 260 can be used for the system based on operation statuses of a plurality of the self-propelled image forming apparatuses 200, and a determination result of the maintenance requirement/non-requirement of each one of the self-propelled image forming apparatuses 200. The traveling-route determination unit 3006 calculates a travel route based on the position of the self-propelled image forming apparatus 200, position information of a user that inputs a print request, and map data.

A description is given of processes performed in the autonomous traveling and image forming system 1 with reference to FIG. 10. FIG. 10 is an example of sequential chart of processes performed in the autonomous traveling and image forming system 1.

The autonomous traveling and image forming system 1 including the server 300, the image forming apparatus 210, and the autonomous traveling apparatus 260 can be operated with an instruction input by the user 3. Specifically, when a printing operation is to be performed in the autonomous traveling and image forming system 1, the user 3 accesses the server 300 via the host terminal 100, and then the host terminal 100 outputs a print request to the server 30 (step S001), in which the user 3 can designate a print condition and a print file via the network 2. Further, the server 300 can acquire information of a print-performing location linked to the host terminal 100 based on uniform resource locator (URL) information stored in the server 300.

When the server 300 receives information related to the printing operation and the print-performing location, the server 300 refers a management list retained in the third data storing unit 3003 to check the operation status of one or more of self-propelled image forming apparatuses 200 being managed by the server 300 to select at least one of the plurality of self-propelled image forming apparatuses 200 to be used for the printing operation in the system, and instructs the selected self-propelled image forming apparatus 200 to move or travel to the host terminal 100 (i.e., user 3) to perform the printing operation (step S002).

Then, the server 300 generates a travel route of the selected self-propelled image forming apparatus 200 based on the position information of the selected self-propelled image forming apparatus 200, the position information of the user 3, and map data retained in the server 300 (step S003).

After the server 300 generates the travel route of the selected self-propelled image forming apparatus 200, the server 300 reports the travel route to the autonomous traveling apparatus 260 of the selected self-propelled image forming apparatus 200, and instructs the autonomous traveling apparatus 260 to start to move (step S004).

When the autonomous traveling apparatus 260 receives a movement instruction from the server 300, the self-propelled image forming apparatus 200 autonomously travels using the autonomous traveling apparatus 260, and moves or travels to a location of the user 3 (step S005).

When the self-propelled image forming apparatus 200 has moved or traveled to the location of the user 3, the autonomous traveling apparatus 260 reports that the autonomous traveling apparatus 260 has arrived at a target destination to the server 300 (step S006).

When the server 300 receives the arrival report from the autonomous traveling apparatus 260, the server 300 converts the print data based on the designated print condition and the print file by using a driver installed in the server 300, and reports the print data to the image forming apparatus 210 (step S007). Then, the image forming apparatus 210 performs the printing operation based on the print data received from the server 300 (step S008).

When the self-propelled image forming apparatus 200 completes the printing operation and the user 3 receives a print product (step S009), the user 3 may want to continue to the printing operation to print another document, in which the user 3 can press a print continue button displayed on the operation panel 214 (i.e., operation unit) of the image forming apparatus 210. When the print continue button is pressed, a print continuation is requested to the image forming apparatus 210 (step S010). When the image forming apparatus 210 receives the print continuation request, the image forming apparatus 210 reports to the server 300 that the image forming apparatus 210 receives the print continuation request from the user 3 (step S011).

When the server 300 receives the print continuation request from the image forming apparatus 210, the server 300 determines whether the print continuation request is allowed for the image forming apparatus 210 (step S012). Specifically, the server 300 compares an allowable waiting time length set for continued-printing operation, which is pre-set for the image forming apparatus 210, and expected next arrival time of the self-propelled image forming apparatus 200 to the user that has input the print continuation request. The expected next arrival time is a total time length including a predicted operation performing time required to perform one or more operations at other one or more subsequent users set in the delivery schedule, and a predicted return movement time required to move the self-propelled image forming apparatus 200 to other one or more subsequent users, and then to move again to the user that has input the print continuation request.

As above mentioned, the expected next arrival time is a total time length of the predicted operation performing time and the predicted return movement time. The predicted operation performing time is a time length required to perform the printing operations at other one or more subsequent users set in the delivery schedule. The predicted operation performing time can be calculated by predicting the number of pages from print data size used at other one or more subsequent users, and then multiplying the predicted number of pages and the printing time per one page. Further, the predicted operation performing time can be calculated by requesting other one or more subsequent users to input the number of pages when one or more subsequent users input data, and then multiplying the input number of pages and the printing time per one page. The predicted return movement time is a time length required to move the self-propelled image forming apparatus 200 to other one or more subsequent users set in the delivery schedule, an then to the user 3 that has requested the print continuation. The predicted return movement time can be calculated by converting the distance on the map to an actual distance for other one or more subsequent users, and the user that has input the print continuation request, and by dividing the actual distance with the travel speed of the autonomous traveling apparatus 260.

If the allowable waiting time length set for continued-printing operation is shorter than the expected next arrival time (i.e., allowable waiting time length set for continued-printing operation < expected next arrival time), the server 300 determines that the user 3 can continue the printing operation at the user 3, and the server 300 instructs the self-propelled image forming apparatus 200 to stay at the current location instead of moving to the next user (step S013).

The allowable waiting time length set for continued-printing operation means the time length that one user can wait for the continued-printing operation after the one user presses the print continue button. For example, the allowable waiting time length set for continued-printing operation can be set, for example, five minutes, by the administrator of the system. If the allowable waiting time length set for continued-printing operation is five minutes, the one user can wait up to five minutes to perform the continued-printing operation, but the one user cannot wait the time longer than five minutes to perform the continued-printing operation. For example, when the user A receives a print product of the first job and then presses the print continue button for the printing operation of the second job at the user A at 15:00 (i.e., current timer), and the expected next arrival time that the self-propelled image forming apparatus 200 can perform the printing operation of the second job may be predicted after 15:05 (i.e., expected next arrival time), the expected next arrival time becomes longer than the allowable waiting time length set for continued-printing operation, in which the self-propelled image forming apparatus 200 cannot perform the printing operation of the second job at the user A before 15:05.

In this case (i.e., expected next arrival time becomes longer than the allowable waiting time length set for continued-printing operation), the self-propelled image forming apparatus 200 performs the printing operation of the second job at the user A after performing the printing operation of the first job and pressing the print continue button before moving to other user, with which the user A does not have to wait the printing operation of the second job, and thereby the user A can receive the print product of the first job and the print product of the second job. By contrast, if it is expected that the self-propelled image forming apparatus 200 can perform the printing operation of the second job at user A at 15:03 (i.e., expected next arrival time) when the user A presses the print continue button at 15:00 (i.e., current timer), the continued-printing request is cancelled, and the self-propelled image forming apparatus 200 moves to other subsequent user to perform the printing operation at other subsequent user, and then returns to the user A at 15:03.

When the self-propelled image forming apparatus 200 receives the stay instruction from the server 300, the self-propelled image forming apparatus 200 displays a message that the user 3 can continue the printing operation, and a message that the self-propelled image forming apparatus 200 is waiting for an input of another print data on the operation panel 214, and waits an input of a print instruction from the user 3. When the user 3 transmits a new print job such as print data to the server 300 (step S015), the server 300 instructs the image forming apparatus 210, which is being in the staying status, to perform the printing operation (step S016), and then the image forming apparatus 210 performs the printing operation at the location of the user 3 (step S017). With this configuration, the user 3 can continue the printing operation requested at step S010, and the user 3 can receive a print product of the continued printing operation at the location of the user 3 (step S018).

Further, at step S001, the location of the host terminal 100 is identified by using uniform resource locator (URL) information, but not limited thereto. For example, the location of the host terminal 100 where the server 300 allows the printing operation (i.e., print-performing location) can be identified by using the position information of the host terminal 100 input by the user 3 when the user 3 accesses the server 300 via the network.

### First Embodiment

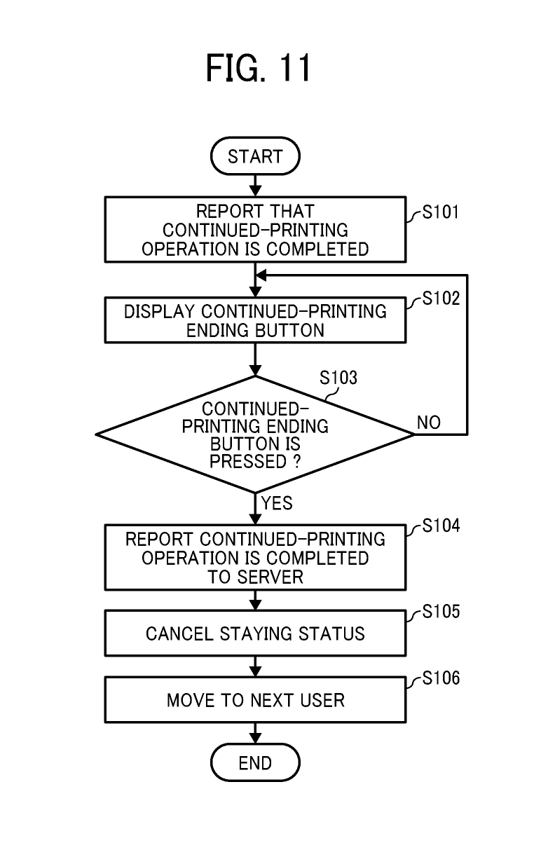

FIG. 11 is a flowchart illustrating steps of a process performed for the image forming apparatus 210 of a first embodiment when the continued printing operation is completed.

As to the sequential chart of FIG. 10, the user 3 requests the print continuation at step S010, the server 300 determines whether the continued-printing operation is allowed at step S012, the server 300 determines that the continued-printing operation is allowed at step S012, the image forming apparatus 210 performs the continued-printing operation at step S017, and then the user 3 receives the print product at step S018. FIG. 11 is a flowchart illustrating steps of a process performable after the process of FIG. 10.

As described in FIG. 11, when the self-propelled image forming apparatus 200 completes the continued-printing operation, the self-propelled image forming apparatus 200 reports that the continued-printing operation is completed to the user 3 (step S101), and displays a continued-printing ending button on the operation panel 214 (step S102). When the entire requested printing operation are completed, and the user 3 presses the continued-printing ending button (step S103), the self-propelled image forming apparatus 200 reports that the continued-printing operation is completed to the server 300 (step S104). When the server 300 receives the report from the self-propelled image forming apparatus 200, the server 300 cancels the staying status of the self-propelled image forming apparatus 200 (step S105). When the staying status of the self-propelled image forming apparatus 200 is cancelled, the self-propelled image forming apparatus 200 receives the travel route to a next host terminal 100 (next user 3) from the server 300 (step S004 in FIG. 10), and moves again (step S006 of FIG. 10).

As to the above described first embodiment, if the continued-printing operation is allowed, the self-propelled image forming apparatus 200 can be set with the staying status until the user 3 presses the continued-printing ending button (steps S102 and 103), with which the user 3 can continue the requested printing operation at the current location of the user 3.

### Second Embodiment

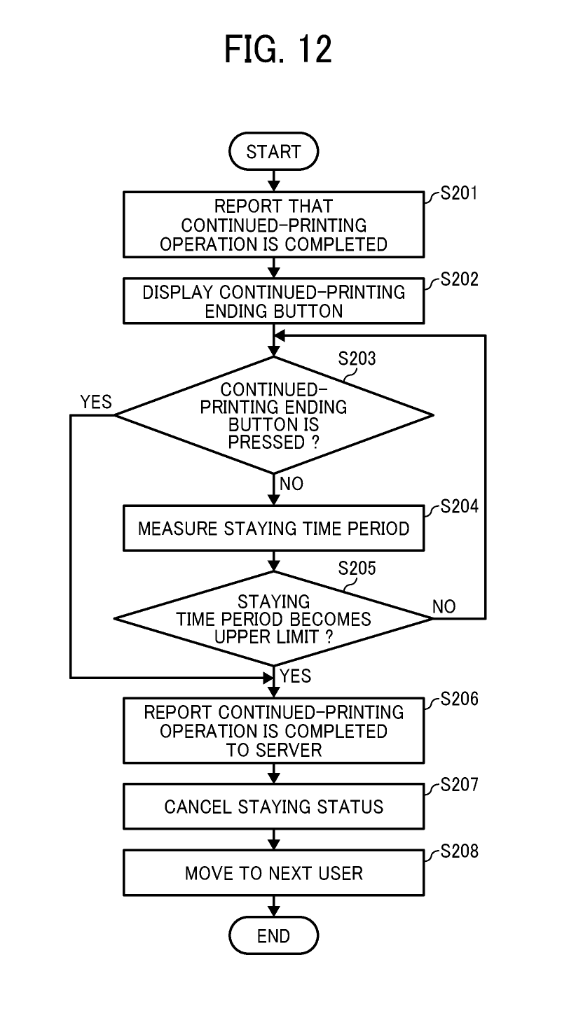

FIG. 12 is a flowchart illustrating steps of a process of the image forming apparatus 210 of a second embodiment when the continued printing operation is completed.

As to the second embodiment, if the staying time period after performing the continued printing operation becomes too long, the staying status of the self-propelled image forming apparatus 200 is cancelled. As to the first embodiment, when the user 3 presses the continued-printing ending button displayed on the operation panel 214 of the image forming apparatus 210, the image forming apparatus 210 ends the continued-printing operation, and then the image forming apparatus 210 moves to a next user 3. However, the image forming apparatus 210 is being set with the staying status until the user 3 presses the continued-printing ending button. Therefore, if the user 3 forgets to press the continued-printing ending button, the self-propelled image forming apparatus 200 cannot move to the next user 3, or the self-propelled image forming apparatus 200 cannot restart the delivery.

The second embodiment is devised in view of the forgetting of the pressing the continued-printing ending button. Specifically, when the image forming apparatus 210 completes one continued-printing operation, the image forming apparatus 210 measures the staying time period. If the staying time period exceeds the pre-set time, the staying status of the self-propelled image forming apparatus 200 is cancelled to resume the movement or delivery of the self-propelled image forming apparatus 200 to the next user.

As described in FIG. 12, when the image forming apparatus 210 completes the continued-printing operation, the image forming apparatus 210 reports that the continued-printing operation is completed to the user 3 (step S201), and displays the continued-printing ending button on the operation panel 214 (step S202). If the user 3 presses the continued-printing ending button, the subsequent sequence proceeds same as the first embodiment. By contrast, if the user 3 does not press the continued-printing ending button, the image forming apparatus 210 measures the staying time period (step S204), and determines whether the staying time period becomes an upper limit of the staying time period pre-set by an administrator of the system (step S205).

If the staying time period is shorter than the upper limit of the staying time period (i.e., measured staying time period < upper limit of staying time period) (step S205: No), the image forming apparatus 210 returns to step S203 that determines whether the user 3 presses the continued-printing ending button, and the sequence proceeds to subsequent process.

By contrast, if the staying time period becomes the upper limit of the staying time period (i.e., measured staying time period ≧ upper limit of staying time period) (step S205: YES), the image forming apparatus 210 reports to the server 300 that the continued-printing operation is ended (step S206). Then, the server 300 transmits a request for cancelling the staying status to the image forming apparatus 210, and the image forming apparatus 210 cancels the staying status (step S207), and the self-propelled image forming apparatus 200 resumes the movement or delivery of the self-propelled image forming apparatus 200 to the next user 3 (step S208).

If new print data is input during the staying status (steps S203→S204→S205→S203), the sequence returns to START after completing the printing of new print data.

As to the second embodiment, if the user 3 does not press the continued-printing ending button and a given time period elapses (steps S203, 204, 205), the staying status of the self-propelled image forming apparatus 200 is canceled (step S207), and then the self-propelled image forming apparatus 200 resumes the movement or delivery of the self-propelled image forming apparatus 200 to the next user 3 (step S208). With this configuration, even if the user 3 forgers to press the continued-printing ending button, the self-propelled image forming apparatus 200 can move or deliver to the next user 3 without too much waiting time at the next user 3.

### Third Embodiment

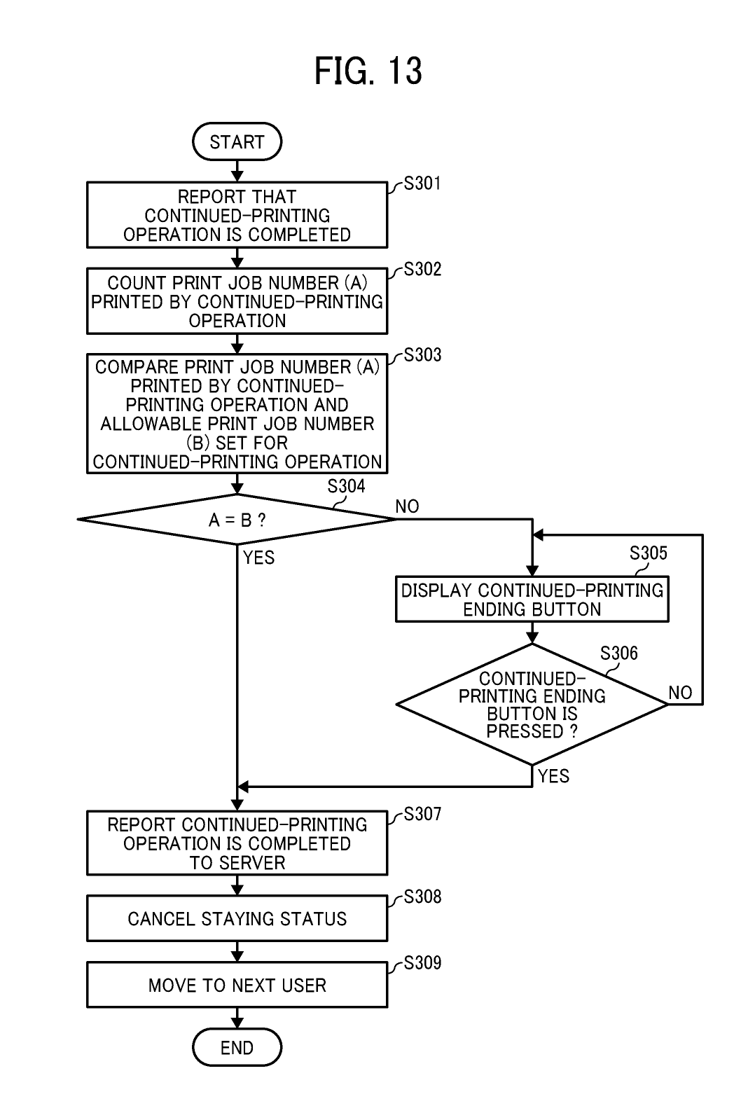

FIG. 13 is a flowchart illustrating steps of a process of the image forming apparatus 210 of a third embodiment when the continued printing operation is completed.

As to the second embodiment, when the staying status continues for a given time period, the continued-printing operation is ended, and the staying status is cancelled. However, if one user 3 continues the printing operation within the upper limit of the staying time period, the image forming apparatus 210 is being stayed at the one user 3, with which other user 3 included in the delivery schedule of the image forming apparatus 210 cannot receive print products for a longer period of time.

In view of issue, as to the third embodiment, the number of print jobs that the continued-printing operation can be performed is set. Specifically, when the number of print jobs becomes the upper limit number of print jobs that the continued-printing operation can be performed, the continued-printing operation is ended.

As described in FIG. 13, when the image forming apparatus 210 completes the continued-printing operation, the image forming apparatus 210 reports the completion of printing operation to the user 3 (step S301), and the image forming apparatus 210 counts the number of print jobs printed by the continued-printing operation at the user 3 as a print job number (A) printed by the continued-printing operation (step S302). Then, the image forming apparatus 210 compares the print job number (A) printed by the continued-printing operation and an allowable print job number (B) set as an allowable upper limit of the continued-printing operation (step S303). The image forming apparatus 210 determines whether the printed print job number (A) is equal to the allowable print job number (B) (step S304).

If the print job number (A) is not equal to the allowable print job number (B) (A≠B) (step S304: No), the image forming apparatus 210 displays the continued-printing ending button on the operation panel 214 (step S305), and then the user 3 determines whether the continued-printing operation is ended or continued (step S306). This determination is performed by an operation to the continued-printing ending button. If the user 3 presses the continued-printing ending button (step S307: YES), the sequence proceeds to step S307, and the continued-printing operation is ended. By contrast, if the user 3 does not press the continued-printing ending button (step S306: NO), the image forming apparatus 210 determines that the continued-printing operation is being continued, and returns to step S305, and the image forming apparatus 210 waits until the user 3 presses the continued-printing ending button.

By contrast, if the print job number (A) becomes the allowable print job number (B) (A=B) (step S304: YES), the number of print jobs printed by the continued-printing operation becomes the upper limit of allowable print job number, and the image forming apparatus 210 reports to the server 300 that the continued-printing operation is ended (step S307). Then, the server 300 transmits a request for cancelling the staying status to the image forming apparatus 210 to cancel the staying status of the image forming apparatus 210 (step S308), and instructs the image forming apparatus 210 to move to a next user 3 (step S309).

As to the third embodiment, even if the user 3 repeatedly continues the continued-printing operation without pressing the continued-printing ending button before the staying time period elapses (steps S304, S305), the continued-printing operation is ended when the number of print jobs printed by the continued-printing operation becomes the upper limit of the allowable print job number (step S304, S307), and then the self-propelled image forming apparatus 200 moves to the next user 3 (steps S308, S309). With this configuration, the occupation of the image forming apparatus 210 by one user 3 by continuing the continued-printing operation can be prevented, with which the self-propelled image forming apparatus 200 can move to the next user 3 without too much waiting time at the next user 3.

The above described embodiment includes the following configurations.

(1) The server 300 of the above described embodiment is couplable to the information processing apparatus (host terminal 100) and the self-propelled image forming apparatus (self propelled image forming apparatus 200) via the network 2. The server 300 includes a receiver (third communication unit 3001) to receive a print condition, a print file and position information of the host terminal 100 from the host terminal 100 coupled to the server 300 via the network 2, a travel route generator (traveling-route determination unit 3006) to generate a travel route of the self-propelled image forming apparatus 200 based on the position information of the host terminal 100, position information of self-propelled image forming apparatus (self-propelled image forming apparatus 200) to be used, and map data, a continued-printing determination unit (third data processing unit 3002) to determine whether the continued-printing operation is allowed for the self-propelled image forming apparatus 200 when the server 300 receives a print continuation request from the self-propelled image forming apparatus 200 coupled to the server 300 via the network 2, a stay instruction unit (third data processing unit 3002) to instruct the self-propelled image forming apparatus 200 to stay at a current location if the continued-printing operation is allowed, and a continued-printing print data transmitter (third data processing unit 3002, third communication unit 3001) to identify continued-printing print data used for the continued-printing operation transmitted from the information processing apparatus, and to transmit the continued-printing print data to the self-propelled image forming apparatus 200 that is being in a staying status at the current location.

In the above described configuration, the self-propelled image forming apparatus 200 is scheduled to move or travel among a plurality of users such as a first user and a second user to perform the printing operation at each one of the plurality of users with a given travelling sequence among the plurality of users such as the first printing operation is performed at the first user, and then the second printing operation is performed at the second user. When the self-propelled image forming apparatus 200 comes to the first user and the first printing operation is performed at the first user, the first user wants to continue an additional printing operation by using the self-propelled image forming apparatus 200. In this case, the self-propelled image forming apparatus 200 can stay at the first user to perform the additional printing operation so that the first user can receive a print product of the additional printing operation before the self-propelled image forming apparatus 200 moves or travels to the second user, with which the first user does not have to wait that the self-propelled image forming apparatus 200 to perform the additional printing operation at the first user even if the self-propelled image forming apparatus 200 is scheduled to move or travel from the first user to the second user.

The travel route generator (traveling-route determination unit 3006) performs the process of step S003. The stay instruction unit performs the process of step S013 to instruct the self-propelled the image forming apparatus 210 to stay at the current location. The continued-printing print data transmitter identifies the continued-printing print data received from the user 3, and transmits the continued-printing print data to the image forming apparatus 210 that is being in the staying status to perform the process of step S016.

(2) The server 300 includes a reporting unit (third data processing unit 3002, third communication unit 3001). When the self-propelled image forming apparatus 200 reports that the self-propelled image forming apparatus has arrived at a destination to the server 300, the reporting unit (third data processing unit 3002, third communication unit 3001) converts data so that the print file can be printed using the received print condition, and reports the converted data to the self-propelled image forming apparatus 200. With this configuration, when the self-propelled image forming apparatus 200 reports that the self-propelled image forming apparatus 200 has arrived at the destination to the server 300, the self-propelled image forming apparatus 200 can output or deliver the print file received from the host terminal 100 at the destination.

The server 300 includes the print data converter 3004 that converts data so that the print file can be printed using the received print condition.

(3) The server 300 includes the continued-printing determination unit (third data processing unit 3002). When the server 300 receives the print continuation request from the self-propelled image forming apparatus 200, the continued-printing determination unit (third data processing unit 3002) compares the allowable waiting time length set for continued-printing operation set for the self-propelled image forming apparatus 200, and the expected next arrival time of the self-propelled image forming apparatus 200. The continued-printing determination unit determines that the continued-printing operation is allowed when the allowable waiting time length set for continued-printing operation is shorter than the expected next arrival time. The server 300 can effectively determine whether the continued-printing operation is allowed.

The self-propelled image forming apparatus 200 reports that the self-propelled image forming apparatus 200 has arrived at the destination at step S006. The continued-printing determination unit determines the continued-printing operation is allowed at step S012.

(4) The image forming apparatus (self-propelled image forming apparatus 200) of the above described embodiment includes the autonomous traveling apparatus (autonomous traveling apparatus 260) to travel autonomously based on an instruction received from the server 300, and the image forming unit (image forming apparatus 210). The image forming unit includes the printing unit 2107 to interpret data received from the server 300, generate print image, and perform the printing operation, a reporting unit (first data processing unit 2102, first communication unit 2101) to report a request for a continued-printing operation to the server 300, a stay instruction receiver (first communication unit 2101, first data processing unit 2102) to receive the stay instruction from the server 300 when the continued-printing operation is allowed for the self-propelled image forming apparatus 200 at a current location of the self-propelled image forming apparatus 200, a print controller (first data processing unit 2102) to print a print data used for the continued-printing operation received from the server 300 at the current location of the self-propelled image forming apparatus 200 being in a staying status by using the printing unit 2107, a continued-printing-ending determination unit (first data processing unit 2102) to determine the ending of the continued-printing operation, a staying status cancelling unit (first data processing unit 2102) to report the continued-printing-ending to the server 300, and cancels the staying status when it is determined the continued-printing-ending occurs.

In the above described configuration, the self-propelled image forming apparatus 200 is scheduled to move or travel among a plurality of users such as a first user and a second user to perform the printing operation at each one of the plurality of users with a given travelling sequence among the plurality of users such as the first printing operation is performed at the first user, and then the second printing operation is performed at the second user. When the self-propelled image forming apparatus 200 comes to the first user and the first printing operation is performed at the first user, the first user wants to continue an additional printing operation by using the self-propelled image forming apparatus 200. In this case, the self-propelled image forming apparatus 200 can stay at the first user to perform the additional printing operation so that the first user can receive a print product of the additional printing operation before the self-propelled image forming apparatus 200 moves or travels to the second user, with which the first user does not have to wait that the self-propelled image forming apparatus 200 to perform the additional printing operation at the first user even if the self-propelled image forming apparatus 200 is scheduled to move or travel from the first user to the second user.

The image generator 2106 interprets data received from the server 300, generates print image, and the printing unit 2107 prints the print image at step S008. The reporting unit (first data processing unit 2102, first communication unit 2101) reports the request for a continued-printing operation to the server 300 at step S011. The print controller (first data processing unit 2102) prints print data used for the continued-printing operation received from the server 300 at the current location of the self-propelled image forming apparatus 200 being in a staying status by using the printing unit 2107 at step S017. Further, the staying status cancelling unit (first data processing unit 2102) reports the continued-printing-ending to the server 300 at steps S104, S206 and S307, and cancels the staying status at steps S105, S207 and S308.

(5) The autonomous traveling apparatus (autonomous traveling apparatus 260) includes the controller (traveling controller 2606) to control a traveling of the autonomous traveling apparatus 260 based on a travel route received from the server 300 while communicating with the server, and the reporting unit (second data processing unit 2602, the second communication unit 2601) to report that the autonomous traveling apparatus 260 has arrived at a destination to the server 300. As to the image forming apparatus (self-propelled image forming apparatus 200), the server 300 instructs the travel route to the destination to the autonomous traveling apparatus (autonomous traveling apparatus 260). Therefore, when the autonomous traveling apparatus 260 moves along the travel route, and then the self-propelled image forming apparatus 200) has arrived at the destination, the server 300 can recognize that the self-propelled image forming apparatus 200) has arrived at the destination.

(6) The image forming apparatus (self-propelled image forming apparatus 200) includes the operation unit (operation panel 214) to display the continued-printing ending button. The continued-printing-ending determination unit (first data processing unit 2102) determines the continued-printing operation is ended when the continued-printing ending button is operated (step S103: YES). As to the image forming apparatus (self-propelled image forming apparatus 200), when the continued-printing is allowed, the user 3 can continue the printing operation until the user 3 presses the continued-printing ending button, which means the user 3 does not have to wait the next-time visit of the image forming apparatus (self-propelled image forming apparatus 200) to receive a print product.

(7) The continued-printing-ending determination unit (first data processing unit 2102) determines that the continued-printing operation is ended (step S206) when the staying time period of the image forming apparatus becomes an upper time limit (step S205: YES). As to the image forming apparatus (self-propelled image forming apparatus 200), even if one user 3 forgets to press the continued-printing ending button, the self-propelled image forming apparatus 200 can move to the next user 3 without too much waiting time at the next user 3, with which the next user can receive a print product without too much waiting time.

(8) The image forming apparatus (self-propelled image forming apparatus 200) includes the print job generator (image generator 2106, first data processing unit 2102) to generate a print job based on data received from the server 300. When a print job number printed by the continued-printing operation becomes an upper limit of an allowable print job number (step S304: YES), the continued-printing-ending determination unit (first data processing unit 2102) determines that the continued-printing operation is ended (step S307). As to the image forming apparatus (self-propelled image forming apparatus 200), even if the user 3 repeatedly continues the continued-printing operation without pressing the continued-printing ending button before the staying time period elapses (steps S304, S305), the continued-printing operation is ended when the number of print jobs printed by the continued-printing operation becomes the upper limit of the allowable print job number (step S304, S307), and then the self-propelled image forming apparatus 200 moves to the next user 3 (steps S308, S309). With this configuration, the occupation of the image forming apparatus 210 by one user 3 by continuing the continued-printing operation can be prevented, with which the self-propelled image forming apparatus 200 can move to the next user 3 without too much waiting time at the next user 3.

(9) The image forming system of the above described embodiment includes the server 300 of any one of (1) to (3), and the image forming apparatus (self-propelled image forming apparatus 200) of any one of (4) to (8) coupled to the server via a network 2. Therefore, the image forming system of the above described embodiment has the effect of any one of (1) to (8).

As to the above described embodiment, the self-propelled image forming apparatus 200 is scheduled to move or travel among a plurality of users such as a first user and a second user to perform the printing operation at each one of the plurality of users with a given travelling sequence among the plurality of users such as the first printing operation is performed at the first user, and then the second printing operation is performed at the second user. When the self-propelled image forming apparatus 200 comes to the first user and the first printing operation is performed at the first user, the first user wants to continue an additional printing operation by using the self-propelled image forming apparatus 200. In this case, the self-propelled image forming apparatus 200 can stay at the first user to perform the additional printing operation so that the first user can receive a print product of the additional printing operation before the self-propelled image forming apparatus 200 moves or travels to the second user, with which the first user does not have to wait that the self-propelled image forming apparatus 200 to perform the additional printing operation at the first user even if the self-propelled image forming apparatus 200 is scheduled to move or travel from the first user to the second user.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions. Further, the above described image processing method performable in the image processing apparatus can be described as a computer-executable program, and the computer-executable program can be stored in a ROM or the like in the image processing apparatus and executed by the image processing apparatus. Further, the computer-executable program can be stored in a storage medium or a carrier such as compact disc-read only memory (CD-ROM), digital versatile disc-read only memory (DVD-ROM) or the like for distribution, or can be stored on a storage on a network and downloaded as required.

Numerous additional modifications and variations for the communication terminal, information processing system, and information processing method, a program to execute the information processing method by a computer, and a storage or carrier medium of the program are possible in light of the above teachings. It is therefore to be understood that within the scope of the appended claims, the disclosure of the present disclosure may be practiced otherwise than as specifically described herein. For example, elements and/or features of different examples and illustrative embodiments may be combined each other and/or substituted for each other within the scope of this disclosure and appended claims.

Numerous additional modifications and variations are possible in light of the above teachings. It is therefore to be understood that within the scope of the appended claims, the disclosure of the present disclosure may be practiced otherwise than as specifically described herein. For example, elements and/or features of different examples and illustrative embodiments may be combined each other and/or substituted for each other within the scope of this disclosure and appended claims.

What is claimed is:

1. A server comprising:
circuitry to
receive, from an information processing apparatus via a network, a print condition, a print file to be printed, and position information of the information processing apparatus;
generate a travel route of a self-propelled image forming apparatus to be used in printing the print file, based on the position information of the information processing apparatus, position information of the self-propelled image forming apparatus, and map data;
instruct the self-propelled image forming apparatus to move to a destination according to the travel route;
determine, in response to a print continuation request received from the self-propelled image forming apparatus, whether a continued-printing operation is allowed for the self-propelled image forming apparatus;
instruct the self-propelled image forming apparatus to stay at a current location when the circuitry determines that the continued-printing operation is allowed for the self-propelled image forming apparatus at the current location, the current location being the destination;
identify continued-printing print data to be used for the continued-printing operation transmitted from the information processing apparatus; and
transmit the continued-printing print data to the self-propelled image forming apparatus being stayed at the current location.

2. The server of claim 1, wherein, when the server receives a notification from the self-propelled image forming apparatus that the self-propelled image forming apparatus has arrived at the destination, the circuitry converts the print file according to the received print condition, and transmits the converted print file to the self-propelled image forming apparatus to cause the self-propelled image forming apparatus to print the converted print file.

3. The server of claim 1, wherein when the server receives the print continuation request, the circuitry compares an allowable waiting time length for continued-printing operation set for the self-propelled image forming apparatus, and a time length determined by an expected next arrival time of the self-propelled image forming apparatus, and determines that the continued-printing operation is allowed for the self-propelled image forming apparatus at the current location when the allowable waiting time length for continued-printing operation is shorter than the time length determined by the expected next arrival time.

4. An image forming apparatus communicable with a server via a network, the image forming apparatus comprising;
an autonomous traveling apparatus to travel autonomously based on an instruction received from the server; and
an image forming unit including first circuitry to
receive data from the server via the network;
interpret the received data to generate a print image to be used for a printing operation;
report a request for a continued-printing operation to the server;
receive a stay instruction from the server when the continued-printing operation is allowed for the image forming apparatus at a current location of the image forming apparatus;
receive print data used for the continued-printing operation from the server;
print the print data used for the continued-printing operation received from the server at the current location of the image forming apparatus being in a staying status;
determine whether the continued-printing operation is ended;
report that the continued-printing operation is ended to the server when an end of the continued-printing operation is determined; and
cancel the staying status of the image forming apparatus when the end of the continued-printing operation is determined.

5. The image forming apparatus of claim 4, wherein the autonomous traveling apparatus includes circuitry to control a traveling of the autonomous traveling apparatus based on a travel route received from the server while communicating with the server, and to report that the autonomous traveling apparatus has arrived at a destination to the server.

6. The image forming apparatus of claim 4, further comprising:
an operation unit to display a continued-printing ending button,
wherein the circuitry determines that the continued-printing operation is ended when the continued-printing ending button is operated.

7. The image forming apparatus of claim 4, wherein the first circuitry determines that the continued-printing operation is ended when a staying time period of the image forming apparatus reaches an upper time limit.

8. The image forming apparatus of claim 4, wherein the first circuitry generates a print job based on data received from the server, and the circuitry determines that the continued-printing operation is ended when a number of print jobs printed by the continued-printing operation becomes reaches an upper limit of an allowable print job number set for the continued-printing operation.

9. An image forming system comprising;
a server; and
an image forming apparatus coupled to the server via a network,
wherein the server including circuitry to
receive, from an information processing apparatus via a network, a print condition, a print file to be printed, and position information of the information processing apparatus;
generate a travel route of a self-propelled image forming apparatus to be used in printing the print file, based on the position information of the information processing apparatus, position information of the self-propelled image forming apparatus, and map data;
instruct the self-propelled image forming apparatus to move to a destination according to the travel route;
determine, in response to a print continuation request received from the self-propelled image forming apparatus, whether a continued-printing operation is allowed for the self-propelled image forming apparatus;
instruct the self-propelled image forming apparatus to stay at a current location when the circuitry determines that the continued-printing operation is allowed for the self-propelled image forming apparatus at the current location, the current location being the destination;
identify continued-printing print data to be used for the continued-printing operation transmitted from the information processing apparatus; and
transmit the continued-printing print data to the self-propelled image forming apparatus being stayed at the current location,
wherein the image forming apparatus including:
an autonomous traveling apparatus to travel autonomously based on an instruction from the server; and
an image forming unit including circuitry to
receive data from the server via the network;
interpret the received data to generate print image to be used for a printing operation;
report a request for a continued-printing operation to the server
receive a stay instruction from the server when the continued-printing operation is allowed for the image forming apparatus at a current location of the image forming apparatus;
receive print data used for the continued-printing operation from the server;
print the print data used for the continued-printing operation received from the server at the current location of the image forming apparatus being in a staying status;
determine whether the continued-printing operation is ended;
report that the continued-printing operation is ended to the server when an end of the continued-printing operation is determined; and
cancel the staying status of the image forming apparatus when the end of the continued-printing operation is determined.
